(19) United States
(12) Patent Application Publication
(10) Pub. No.: US 2012/0040067 A1
(43) Pub. Date: Feb. 16, 2012

(54) SEQUENTIAL COOKING UTENSIL, A CORRESPONDING SYSTEM, AND A CORRESPONDING METHOD

(76) Inventors: Eric Laurent Baraille, Fontaine Les Dijon (FR); Guillaume Cohade, Reims (FR); Marie-Pierre Murat, Fontaine Les Dijon (FR)

(21) Appl. No.: 13/143,504

(22) PCT Filed: Jan. 14, 2010
(86) PCT No.: PCT/FR2010/050052

§ 371 Date: Sep. 29, 2011

(30) Foreign Application Priority Data
Jan. 15, 2009 (FR) 09 50239

(51) Int. Cl. A47J 27/08; A23L 1/01; A47J 43/28

(52) U.S. Cl. 426/523; 99/342

(57) ABSTRACT

The invention relates to an utensil (1) for cooking food by subjecting said food to a heat source, said utensil (1) being characterized in that it is provided with a cooking management device (7) that is designed to emit firstly a first signal either for causing the heat source to be switched off or for urging the user to switch off the heat source, and secondly a second signal subsequent to the first signal and that indicates to the user that cooking is finished. Appliances for cooking food.

### TECHNICAL FIELD

The present invention relates to the general technical field of household cooking utensils, and in particular to the sector of pressure-cookers, i.e. pressure-cooking utensils designed to enable food contained in them to be cooked under steam pressure.

The present invention relates more particularly to a cooking utensil for cooking food by subjecting it to a heat source.

The present invention also relates to a food-cooking system comprising firstly a food-cooking utensil and secondly a recipe booklet that indicates a cooking time, for at least one food.

The present invention finally relates to a method of cooking food by subjecting it to a heat source.

### STATE OF THE PRIOR ART

Household pressure cookers are well known. Usually, such a pressure cooker comprises a vessel designed to receive food and a lid designed to be mounted and locked on the vessel so as to co-operate therewith to form a sealed cooking enclosure.

Conventionally, such a pressure cooker is designed to be subjected to the influence of a heat source (such as a hob, for example) in such manner as to enable the enclosure to be brought up to pressure and to temperature, and thus as to enable the food contained in said enclosure to be cooked under steam pressure.

Cooking in a pressure cooker offers certain nutritional and organoleptic advantages over other manners of cooking that do not involve pressure being increased. Steam-cooking under pressure makes it possible to reach temperatures greater than 100° C., thereby enabling cooking to be particularly fast, while nevertheless also preserving most of the nutritional qualities of the food. For example, on average, it takes eight minutes to cook green beans in a good-performance pressure cooker as against thirty minutes in an ordinary saucepan at atmospheric pressure. Numerous scientific studies conducted to date also show that vitamin C preservation in vegetables is considerably better when they are cooked in a pressure cooker than when they are cooked in an ordinary saucepan, for example.

In short, cooking in a pressure cooker is generally not only faster, but also more respectful of the nutritional and organoleptic properties of the foods that are subjected to such cooking.

However, for voluminous foods, such as pieces of meat, pieces of fish, or potatoes, the core of the food takes longer to cook than the outside, i.e. the core of the food does not really start cooking until several minutes after the surface layers of the food start cooking. This is due to the fact that, as in all cooking utensils (with the notable exception of microwave ovens), the heat is applied from the outside of the food.

Therefore, once the outside (i.e. the surface layers) of the food has been cooked, the core of the food is not yet cooked and the heat prevailing inside the cooking enclosure then participates as much in overcooking the outer layers of the food as it does in cooking the core of the food. The surface layers are thus overcooked and therefore lose some of their nutritional and organoleptic qualities.

In addition, the quantity of energy used for such overcooking is wasted, since such overcooking is naturally not desired and, on the contrary, should be avoided.

This over-cooking of the outer layers of the foods, in particular when the foods are voluminous, thus constitutes a serious drawback that dissuades certain users from using a pressure cooker for cooking the foods in question.

In addition, the optimum cooking time for cooking a food in a pressure cooker must be known and complied with scrupulously, insofar as only a few excess minutes of cooking can worsen the above-mentioned phenomenon of overcooking to the extent of it seriously damaging the food (e.g. meats become tough and dry), or even of it destroying the food (potatoes can burst or be reduced to a pulp).

### OBJECT OF THE INVENTION

Objects assigned to the invention are consequently to remedy the various above-listed drawbacks and to propose a novel cooking utensil that makes it possible to optimize the cooking cycle, and in particular to reduce the risk of overcooking, and to save energy, while also being particularly simple and intuitive to use.

Another object of the invention is to propose a novel food-cooking utensil, and in particular a pressure cooker, that makes it possible to perform cooking that is extremely fast, that is particularly respectful of the nutritional and organoleptic qualities of the foods, that the user does not perceive as giving cause for anxiety, and that avoids the user having to wait for a long time before being able to access the food at the end of cooking.

Another object of the invention is to propose a novel food-cooking utensil that is extremely simple and intuitive to use, and that is of a design that limits user errors.

Another object of the invention is to propose a novel food-cooking system that is particularly simple and intuitive, and that does not change the habits of the user.

Another object of the invention is to propose a novel food-cooking system that enables the food to be cooked optimally, by limiting the risk of overcooking, while also allowing energy to be saved.

The objects assigned to the invention are achieved by means of a utensil for cooking food by subjecting said food to a heat source, said utensil being characterized in that it is provided with a cooking management device that is designed to emit firstly a first signal either for causing the heat source to be switched off or for urging the user to switch off the heat source, and secondly a second signal subsequent to the first signal and that indicates to the user that cooking is finished.

The objects assigned to the invention are also achieved by means of a food-cooking system comprising:

firstly a utensil for cooking food by subjecting said food to a heat source, said utensil being provided with a cooking management device that is designed to emit firstly a first signal either for causing the heat source to be switched off or for urging the user to switch off the heat source, and secondly a second signal subsequent to the first signal and that indicates to the user that cooking is finished, said cooking management device being provided with detector means for detecting that a predetermined pressure value has been reached in the enclosure, said cooking management device being designed so that, when said predetermined pressure value is detected, said cooking management device emits a fourth signal that is prior to the first signal and that is designed either to cause the power of the heat source to be reduced, or to urge the user to reduce the power of the heat source, said utensil also being provided with setting means enabling the user to set at least the time that elapses between the fourth signal and the first signal; and

secondly a recipe booklet indicating a cooking time for at least one food, said cooking time indicated in the recipe booklet corresponding to the time elapsing between the fourth signal and the first signal.

The objects assigned to the invention are also achieved by means of a method of cooking food by subjecting said food to a heat source, said method comprising:

a first cooking stage during which the food is disposed in an enclosure subjected to a heat source and in which a pressure prevails that is maintained substantially constant at a predetermined value that is significantly greater than atmospheric pressure;

a second cooking stage during which the heat source is switched off and the pressure value prevailing in the enclosure is progressively reduced to substantially the value of atmospheric pressure; and

a determination step for determining the time of the second cooking stage so that the second cooking stage is implemented for a predetermined time.

### BRIEF DESCRIPTION OF THE DRAWINGS

Other objects, characteristics, and advantages appear in more detail on reading the following description given with reference to the accompanying drawings that are given by way of non-limiting and illustrative example, and in which:

FIG. 1 is a diagrammatic perspective view of a utensil of the invention for cooking food under pressure, said utensil being provided with a pressure selector member mounted to move between five positions, namely one decompression position and four cooking positions, said pressure selector member being shown in its decompression position;

FIG. 2 is a view from above showing the utensil of FIG. 1 with its cooking management device not operative, i.e. not electrically powered;

FIG. 3 is a view from above of a detail of FIG. 2, the pressure selector member being shown in a cooking position that is specially adapted to cooking fish, the cooking management device being activated and ready to be programmed by the user;

FIG. 4 is a view from above of the implementation detail of FIG. 3, the pressure selector member being in the decompression position, while a cooking time of one minute has been programmed by the user on the management device;

FIG. 5 is a view from above of a detail of the view of FIG. 2, the pressure selector member being in the decompression position, while the management device is emitting an error signal;

FIG. 6 is a view from above of a detail of FIG. 3, a cooking time of one minute being programmed on the cooking management device and being displayed by said device;

FIG. 7 is a view from above of a detail of FIG. 6, the cooking management device counting down the cooking time programmed by the user;

FIG. 8 is a view from above of the detail of FIG. 6 at the instant at which the cooking time has been fully counted down, the cooking management device emitting first and third signals urging the user respectively to switch off the heat source and to activate decompression of the utensil;

FIG. 9 is a view from above of the detail of FIG. 8, the pressure selector member being in the decompression position, into which the user was urged to put it (cf. FIG. 8), the cooking management device counting down an additional cooking time and displaying said count-down;

FIG. 10 is a view from above of a detail of the utensil of the invention, the cooking management device emitting a second signal indicating that cooking is finished;

FIG. 11 is a graph showing a prior art cooking method;

FIG. 12 is a graph showing how a cooking method of the invention proceeds;

FIG. 13 is a graph showing the gain in terms of preservation of vitamin B6 obtained by using a cooking method of the invention rather than using a prior art cooking method; and

FIG. 14 is a graph showing the gain in terms of tenderness obtained by using a pressure-cooking method of the invention rather than using a prior art pressure-cooking method.

### BEST MANNER OF IMPLEMENTING THE INVENTION

The invention relates to a cooking utensil 1 for cooking when subjected to a heat source (not shown in the figures). More precisely, the cooking utensil 1 shown in the figures is designed firstly to contain food to be cooked and secondly to be subjected to a heat source that is external to and independent from the utensil 1, in such a manner as to enable the temperature inside the utensil 1 to be increased, thereby cooking the food contained therein. In which case, the cooking utensil 1 constitutes a thermally passive utensil that is designed to be heated under the effect of an independent heat source that is external to it, and that is of the hob type. However, without going beyond the ambit of the invention, it is quite possible for the food-cooking utensil to incorporate a heat source, such an incorporated heat source supplying the heat energy necessary to cook the food.

In the embodiment shown in the figures, the utensil 1 is a pressure cooker, i.e. it enables the food to be cooked under steam pressure, at high temperature. However, the invention is not limited to a utensil for cooking food under pressure, and it may, in particular, relate to a cooking utensil for cooking food substantially at atmospheric pressure.

The utensil 1 is thus advantageously designed to form a cooking enclosure enabling food to be cooked under pressure. In other words, the cooking enclosure in question is sufficiently sealed to enable the pressure prevailing in it to exceed atmospheric pressure significantly when the cooking enclosure is subjected to the thermal power of a heat source, such as a hob. The cooking enclosure may be of any construction known to the person skilled in the art. Advantageously, and as is well known per se, the utensil 1 of the invention comprises firstly a vessel 2 made of a metal material, and forming a cooking receptacle designed to receive the food to be cooked, and secondly a lid 3 designed to be mounted and locked on the lid 2 so as to co-operate therewith to form the cooking enclosure. Advantageously, the lid 3 is designed to be locked onto the lid 2 or to be unlocked therefrom at will, locking the lid 3 enabling the enclosure to be brought up to pressure without the lid 3 coming off in untimely manner under the effect of the increasing pressure inside the enclosure. For this purpose, the pressure cooker 1 is preferably provided with locking/unlocking means 4 for locking/unlocking the lid 3 relative to the vessel 2. The locking/unlocking means 4 may be of any type known to the person skilled in the art, and, for example, as shown in the figures, may be constituted by jaws designed to clamp the peripheral edges of the vessel 2 and of the lid 3, said jaws being mounted to slide radially over the lid 3.

Advantageously, the utensil 1 is provided with regulator means 5 for regulating the value of the pressure prevailing inside the cooking enclosure so as to maintain said pressure at a setpoint value. Such regulator means 5 are well known per se, and are preferably constituted by a pressure regulator valve that is sensitive to the pressure prevailing inside the cooking enclosure and that is mounted to move between:

firstly a sealed closure position, in which it closes off communication between the enclosure and the outside so long as the internal pressure is less than or equal to the setpoint value; and

secondly a leakage position in which it puts the inside of the enclosure into communication with the outside, preferably via a steam outlet 5A, as soon as the pressure prevailing inside the enclosure significantly exceeds the setpoint value.

The regulator valve may be of any type known to the person skilled in the art, and, for example, it may be constituted by a valve loaded by a compression spring and mounted to move inside a well between:

a low position in which it bears, under the effect of the return force exerted by the compression spring, against the lid 3 facing a hole provided therethrough and communicating with the steam outlet 5A; in this stable abutment position, which is a return position, the valve seals off the hole provided through the lid 3 so as to prevent any leakage of steam through said hole and then through the steam outlet 5A; and

at least one high position that the valve takes up under the effect of the pressure prevailing in the enclosure, when said pressure exceeds the setpoint value and thereby exerts on the valve a force opposite to and greater than the return force exerted by the compression spring. In this high position, the valve rises and opens up the hole provided through the lid, and through which steam can then escape to the outside, via the steam outlet 5A.

Advantageously, and as is well known to the person skilled in the art, the utensil 1 is also provided with a pressure selector member 6 enabling the user to set the setpoint of the regulator means 5 for regulating the value of the pressure prevailing in the cooking enclosure.

In other words, the pressure selector member 6 enables the user to select a setpoint value from among a plurality of predetermined setpoint values, so that the cooking pressure regulated by the regulator means 5 is adapted to accommodate the nature of the food to be cooked. Preferably, in order to enable the user to set the setpoint value, the pressure regulator valve that preferably constitutes the regulator means 5 for regulating the value of the pressure prevailing inside the cooking enclosure is provided with a loading system, e.g. constituted by a device making it possible to compress to a greater or lesser extent the compression spring returning the valve to its sealing low position. In which case, as is well known to the person skilled in the art, the pressure selector member 6 enables the user to act on the magnitude of the return force exerted by the compression spring on the regulator valve, by compressing the compression spring to which the regulator valve is subjected to a greater or lesser extent, depending on the position of the pressure selector 6. The user can thus select a setpoint value from among a choice of a plurality of setpoint values, and, for example, as shown in the figures, from among four setpoint values that are described in detail below. Advantageously, the utensil 1 is also provided with a decompression member for decompressing the cooking enclosure, said decompression member being designed so that, when it is activated, it causes the pressure prevailing inside the cooking enclosure to be brought back to or maintained at a value compatible with the lid 3 being unlocked safely, without any risk of the lid coming off suddenly under the effect of the pressure. In other words, the decompression member makes it possible to force the inside of the enclosure into communication with the outside, in order to prevent the pressure in the enclosure from rising or, conversely, to establish steam leakage that is sufficient to bring the pressure level prevailing inside the enclosure back to a level that is sufficiently low to enable the lid 3 to be unlocked from and separated from the vessel 2.

Advantageously, both the pressure selector member 6 and the decompression member are designed to be actuated manually by the user. Preferably, the pressure selector member 6 and the decompression member are constituted by a single, common part that makes it possible both to act on the loading of the regulator valve so as to choose a cooking pressure value, and also to act on the valve itself so as to force it to leave its sealing position and thus to generate decompression of the cooking enclosure. Advantageously, the pressure selector member 6 that also constitutes the decompression member comprises a rotary ring 6A mounted to move in rotation on the lid 3 between:

an open position (also referred to as the “decompression position”) shown in FIGS. 1, 2, 4, 5, 9, and 10, making it possible to cause the pressure prevailing inside the cooking enclosure formed by the vessel 2 and by the lid 3 to be brought back to and maintained at a value compatible with the lid 3 being unlocked safely, the ring 6A interacting with the valve to raise said valve in order to put the inside of the cooking enclosure into forced and continuous communication with the outside, via a leak section that is large enough not only to depressurize the utensil 1 but also to prevent pressure from building up to above a predetermined safety pressure compatible with the lid 3 being unlocked safely;

a first cooking position, corresponding to a first predetermined loading of the regulator valve, and in which the ring 6A interacts with the valve-loading system, and, for example, with the compression spring to which the valve is subjected, so as to set the setpoint value to a first predetermined value, e.g. specifically adapted to cooking vegetables;

a second cooking position, corresponding to a second predetermined loading of the regulator valve, and in which the ring 6A interacts with the valve-loading system, and, for example, with the compression spring to which the valve is subjected, so as to set the setpoint value to a second predetermined value, e.g. specifically adapted to cooking starchy foods (e.g. potatoes);

a third cooking position, corresponding to a third predetermined loading of the regulator valve, and in which the ring 6A interacts with the valve-loading system, and, for example, with the compression spring to which the valve is subjected, so as to set the setpoint value to a third predetermined value, e.g. specifically adapted to cooking meats; and

a fourth cooking position, corresponding to a fourth predetermined loading of the regulator valve, and in which the ring 6A interacts with the valve-loading system, and, for example, with the compression spring to which the valve is subjected, so as to set the setpoint value to a fourth predetermined value, e.g. specifically adapted to cooking fish.

Each of these five above-mentioned positions is advantageously identified by a respective icon 21, 22, 23, 24, 25 disposed on the lid 3 and designed to find itself facing the finger 6B when the corresponding position is selected by the user. Such an interaction between firstly a pressure selector member 6 making it possible to act on the pressure level in the enclosure and secondly regulator means 5 and the system for loading them is very well known per se, and is thus not described in any further detail herein.

By way of indication, such interaction between the pressure selector member 6, the regulator means 5, and the loading system therefor, may, for example, be as taught by the French Patent Application published under No. FR-2 899 454 (filed under No. FR 06/03207), the pressure selector 6 described herein corresponding to the rotary selector 37 and to its control part 28 that are described in the Document FR-2 899 454 in question. In order to make it easy for the user to operate the rotary ring 6A forming the pressure selector member and the decompression member, said ring 6A is provided with a graspable finger 6B that is attached to it, and that the user can take hold of for the purpose of driving the ring 6A in rotation between its five above-mentioned positions, corresponding respectively to an open (decompression) position and to four positions that differ from one another by their predetermined regulated pressure levels.

In accordance with the invention, the utensil 1 is also provided with a cooking management member 7 designed to emit firstly a first signal 8 for urging the user to switch off the heat source and secondly a second signal 9 subsequent to the first signal and that informs the user that cooking is finished. The first signal 8 is thus emitted for the attention of the user for the purpose of urging the user to switch off the heat source, preferably immediately and directly, i.e. to turn off the heat source in question. To this end, in the embodiment described above, the first signal 8 is thus perceptible, preferably directly, by the user. For example, when the heat source is constituted by an electric hob, switching off the heat source corresponds to switching off the electrical power to the resistor (or to the induction or vitroceramic system) of the hob.

When the hob is constituted by a gas hob, switching off the heat source corresponds to switching off the gas feed to the burner of the hob. Thus, switching off the heat source makes it possible to interrupt any energy consumption by the heat source. The term “switching off” therefore does not mean merely a reduction in the heating power but rather a total interruption in energy consumption by the heat source. Such switching off of the heat source contributes to making use much simpler, since the user does not have to perform a potentially complex operation of adjusting the heating level. Naturally, switching off the heat source does not necessarily result immediately in an absence of any heat energy flow from the heat source to the cooking utensil 1, in view of possible thermal inertia effects, in particular when the heat source is constituted by an electric hob based on the Joule effect.

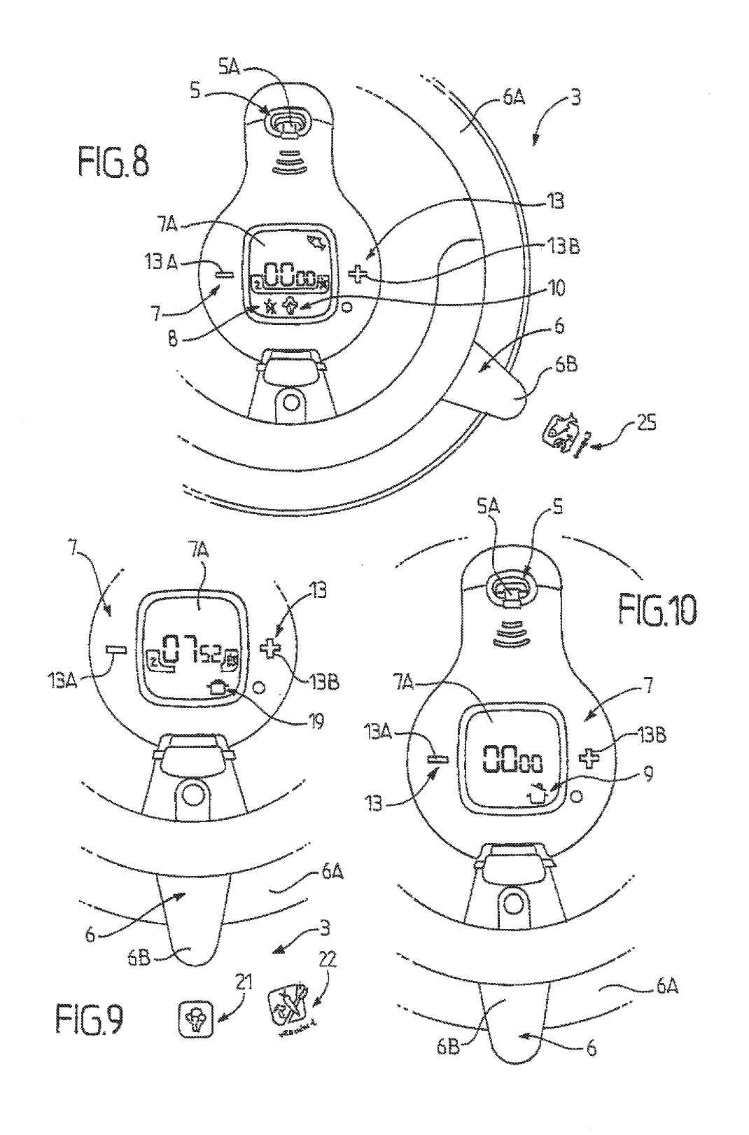

As shown in FIG. 8, the first signal 8 is advantageously of the visible type, and comprises, for example, an icon showing a crossed-out flame symbol, enabling users to understand that they should respond to the signal in question by switching off the heat source. Naturally, it is also possible for the first signal 8 to be audible rather than visible, and then to be constituted by a sound pattern designed to attract the attention of the user. Preferably, the first signal 8 is of the audiovisual type, i.e. it combines displaying an icon with generating a sound, the sound makes it possible to attract the attention of users while the icon, through its figurative nature, making it possible for users to understand what is expected of them, namely, in this example, switching off the heat source.

The first signal 8 is thus not designed merely to reflect an instantaneous state of the utensil 1 but rather genuinely to urge the user to undertake rapidly a positive action of totally interrupting the power supply or fuel supply to the heat source (electric heat source, gas heat source, etc.).

In an embodiment, the utensil 1 may be associated with a user manual (instructions for use), e.g. in the form of a paper brochure, said manual indicating to the user what the first signal 8 means. The invention also relates per se to such a system comprising firstly a cooking utensil 1 as described in the present description and secondly a user manual, e.g. in the form of a booklet, explaining to the user the meaning of the first signal 8 and/or the meanings of the other signals emitted for the attention of the user and considered below and above.

The second signal 9 may also be of entirely visible nature or of entirely audible nature, but, advantageously, like the first signal 8, it is of audiovisual nature. Thus, as shown in FIG. 10, the second signal 9 advantageously comprises an icon representing a receptacle with its lid being lifted off, indicating to users that they can open the lid and retrieve the food, insofar as the cooking cycle is finished. Display of this icon is advantageously accompanied by generation of a sound designed to attract the attention of the user to the fact that the cooking cycle is finished.

In order to enable the first and second signals 8, 9 to be emitted, the cooking management device 7 advantageously has a display screen 7A, e.g. formed by an electronic screen of the Liquid Crystal Display (LCD) type. The cooking management device 7 also advantageously has a sound generator device. The sound generator device and the screen 7A are advantageously both electrically powered by a power supply system that is incorporated in the management device 7, said power supply system preferably being a battery system in order to avoid having to plug in the utensil 1, and thus in order to maintain the independent nature of the utensil 1.

In an alternative variant, not shown in the figures, the first signal 8 is designed to cause the heat source to be switched off. Under such circumstances, the utensil 1 is functionally connected to the heat source so that the first signal 8 causes the heat source to be switched off directly, without involving the user. It is then not necessary to warn the user, and the first signal 8 can then merely be an electrical control signal transmitted to the heat source rather than an information signal as in the above-described variant.

One of the underlying principles of the invention thus consists in switching off the heat source during cooking, rather than at the end of cooking as is customary in the prior art, so that a fraction of the cooking takes place solely by means of the energy stored in the form of temperature (and advantageously pressure) inside the cooking enclosure, by an inertia effect, without any external energy being consumed.

More precisely, in particular for relatively voluminous food items, the second cooking stage that starts as soon as the heat source is switched off by the user as urged by the first signal 8, enables the food to continue to cook through to the core by means of the heat provided by its already-cooked surface layers, without however overcooking the surface layers since the heat source is switched off, the food merely being kept hot.

The invention thus lies in implementing a first cooking stage with the heat source activated and set preferably to its maximum power, thereby making it possible to cook the outer layers of the food rapidly, and acting as a cooking accelerator, and a gentle second cooking stage during which the food remains in the cooking enclosure (the lid 3 remaining closed on the vessel 2), thereby enabling the food to be cooked through to its core without overcooking the surface layers of said food, and without consuming additional energy due to the fact that the heat source is turned off and is then no longer powered or fuelled.

The second cooking stage, which may be referred to as the “inertial cooking stage” insofar as it does not require any energy to be supplied externally to the heat source, thus makes it possible to finish off the cooking cycle gently, with the lid 3 preferably remaining locked on the vessel 2.

The cooking utensil 1 of the invention thus enables the user to implement such a sequential cooking method simply, effectively, and intuitively by urging the user to switch off the heat source at a predetermined moment, and by indicating to the user that cooking is finished at another predetermined moment that occurs subsequently with a predetermined time elapsing between the first signal 8 and the second signal 9, which time is preferably predetermined as a function of the nature of the food to be cooked. By means of this predetermined time, the user is informed as early as possible that cooking is complete, thereby making it possible to reduce the waiting time.

Advantageously, the cooking management device 7 is designed to emit a third signal 10 designed to urge the user to activate the decompression member in order to bring the pressure prevailing inside the cooking enclosure substantially back to atmospheric pressure.

Like the first and second signals 8, 9, the third signal 10 is advantageously of an audiovisual nature, it being understood that it is, however, quite possible for it to be of an audible nature only or of a visible nature only. Thus, in the example shown in FIG. 8, the third signal 10 comprises an icon that is displayed on the screen 7A, and that shows a jet-of-steam symbol, in order to make users understand that they should bring the pressure selector member that also controls decompression back into a decompression position. Display of this icon is accompanied by emission of a sound designed to attract the attention of the user.

Preferably, the cooking management device 7 is designed to emit the first and third signals 8, 10 substantially simultaneously, as shown in FIG. 8. In which case, the user is urged, at the same time, to switch off the heat source and to activate the decompression member for decompressing the cooking enclosure, so as to bring the cooking enclosure inside which the food is placed back to atmospheric pressure. Thus, the utensil 1 of the invention advantageously makes it possible to implement sequential cooking in two stages, namely a pressure-cooking stage, during which the cooking enclosure is subjected to the active influence of a heat source and is pressurized, this pressure-cooking first stage being followed immediately by a “pressure-less” cooking stage during which the heat source is switched off and the cooking enclosure is put into forced communication with the outside so as to be depressurized. The start of this second cooking stage is marked by emission of the first and third signals 8, 10, while the end of the cooking cycle is indicated by the second signal 9, which informs the user that it is possible to open the lid 3 so as to retrieve the food that is cooked properly through to the core, without its surface layers being overcooked.

Naturally, it is quite possible for the third signal 10 to be emitted after the first signal 8, so as to implement in succession:

a pressure-cooking first stage with the heat source on, and preferably set to full power;

a pressure-cooking second stage, with the heat source off; and finally

a pressure-less cooking third stage, with the heat source off.

However, it is particularly advantageous, if only for reasons of simplicity of use, to cause the switching off of the heat source to coincide with the decompression, so that the cooking cycle is made up of only two distinct stages.

By means of this novel, optimized cooking management that is procured by the cooking utensil 1 of the invention, decompression takes place during the cooking cycle rather than at the end thereof as it does in the prior art. This makes it possible to finish off cooking with the pressure and thus the temperature being reduced progressively, thereby avoiding overcooking the food. This also makes greater flexibility of use possible because, when the second signal 9 informs the user that the cooking is finished, the food is not subjected to pressure and temperature levels that are high, so that even if the user does not act immediately to open the lid 3 and to remove the food from the vessel 2, the cooked food does not spoil but rather is merely kept hot without being overcooked. A user forgetting the end of cooking in a conventional pressure cooker has no such second chance. In addition, in the invention, the decompression is an integral part of the cooking cycle, so that decompression is advantageously finished when the second signal 9 is emitted, indicating that cooking is finished. Thus, the user can access the food immediately, without having to wait for the utensil 1 to be decompressed, since decompression has already taken place during the cooking cycle, and more precisely during the second cooking stage. In the prior art, once the cooking time has elapsed, users are constrained to decompress the utensil before they can have access to the food. In order to limit the waiting time in the prior art, decompression is designed to be as fast, and thus as violent, as possible, which is a source of worry for the user.

Conversely, with the food-cooking utensil 1 of the invention, the decompression can be performed with a low steam leakage rate, so as to be slow and therefore gentle and non-violent.

The user is thus not subjected to any phenomenon that might give cause for anxiety of the type such as a sudden release of steam as in the prior art, and the user does not have to wait until after the cooking before it is possible to decompress the utensil 1 fully because the decompression takes place during the second cooking stage, from concomitant emission of the first and third signals 8, 10 until emission of the second signal 9 marking the end of cooking.

By way of an alternative, it is possible, without however going beyond the ambit of the invention, for the cooking management device 7 to be designed to emit a third signal 10 designed itself to cause the decompression member to be activated. In which case, the third signal 10 can be merely an electrical signal that acts via any suitable means to cause the decompression member to be activated in fully independent manner without the user being required to act. In which case, the cooking method can be fully automated, thereby naturally facilitating use of the utensil 1 by limiting the actions of the user and therefore limiting any user errors. In order to limit such errors, it is however possible, in the variant shown in the figures in which the third signal 10 urges the user to activate the decompression member, for the decompression member to be connected to the cooking management device 7 so that the cooking management device 7 emits a reminder signal 11 (cf. FIG. 5) if the decompression member has not been activated by the user in spite of the user being urged to activate it by the third signal 10.

Advantageously, the cooking management device 7 is provided with detector means for detecting that a predetermined pressure value has been reached inside the enclosure, said predetermined value preferably corresponding to the setpoint value selected by the user by means of the pressure selector member 6.

In other words, the detector means make it possible to inform the management device 7 of the start of the regulated-pressure cooking stage. The detection means with which the cooking management device 7 is provided may be of any type known to the person skilled in the art. For example, they may consist of a pressure sensor or of a temperature sensor, insofar as the temperature prevailing in the cooking enclosure is the image of the pressure prevailing in said enclosure. Advantageously, the detector means comprise a temperature sensor disposed at the steam outlet 5A in order to detect the first jet of steam corresponding to the regulator valve opening, which opening indicates that the setpoint value has been reached and thus that the pressure-cooking stage has started. In particular, the temperature sensor in question may be disposed as taught in Document FR-2 834 193 (FR 01/17101) whose content is incorporated into the present description by reference. Advantageously, the cooking management device 7 is designed so that, when said predetermined pressure value is detected by the detector means, said cooking management device emits a fourth signal that is prior to the first signal 8 and that is designed to urge the user to reduce the power of the heat source, i.e. to bring the thermal power emitted by the heat source to an intermediate value lying between the maximum possible value and zero power (corresponding to the heat source being off).

Thus, the user is urged by the fourth signal to reduce the power of the heat source, which does not mean that the heat source is switched off.

In an alternative embodiment, the fourth signal is designed to act by itself to cause the power of the heat source to be reduced, i.e. when the cooking management device 7 is designed to act directly on the heat source, to reduce the power thereof, without action from the user being necessary. In this situation, the fourth signal may be merely an electrical signal making it possible to cause the power of the heat source to be reduced, and it is not necessary for it also to have an audible and/or visible nature because action by the user is not required.

However, preferably and as shown in the figures, the signals 8, 9, 10 that the cooking management device 7 is designed to emit are preferably of audible and/or visible nature.

For example, the heat source may be set to its maximum power until the fourth signal is emitted, and then reduced to about half, or indeed to two-thirds, of its maximum power when the fourth signal is emitted. By implementing maximum heating power at the beginning of the pressure cycle, before the fourth signal is emitted, the pressure builds up rapidly and the setpoint value is reached as rapidly as possible. It suffices for the predetermined pressure level, corresponding to the setpoint value, to be maintained in the cooking enclosure, which does not require the heat source to be set to its maximum power, a setting corresponding to one half, or indeed one fourth, of the maximum power often being amply sufficient.

As indicated above, the fourth signal is prior to the first signal 8, which means that the management device 7 is designed to emit the first signal 8 after the fourth signal, after a predetermined time has elapsed as from the fourth signal.

Advantageously, the utensil 1 of the invention is provided with setting means 13 enabling the user to set at least the time elapsing between the fourth signal and the first signal 8. For example, the setting means 13 are constituted by a keypad having at least two buttons 13A, 13B making it possible respectively to decrement and to increment a time value that is displayed on the screen 7A and that corresponds to the time elapsing between emission of the fourth signal and emission of the first signal 8. Thus, in this preferred embodiment, the user can program the cooking management device 7 so that a predetermined length of time, as chosen by the user, elapses from emission of the fourth signal to emission of the first signal 8.

In other words, the user may, by means of this technical characteristic, choose the length of time of the regulated-pressure cooking stage, as is already possible in the prior art.

Advantageously, the cooking management device 7 is also provided with processor means connected to the pressure selector member 6 so as automatically to set the time elapsing between the first signal 8 and the second signal 9 as a function of the setpoint value selected by the user by means of the pressure selector member 6. In other words, whereas the time elapsing between the fourth signal and the first signal is advantageously set by the user, as a function, for example, of the nature and of the quantity of the food to be cooked, the time elapsing between the first signal 8 and the second signal 9 is determined automatically by the cooking management device 7.

The time elapsing between the first and second signals 8, 9 is advantageously determined by the cooking management device 7 as a function of the position of the pressure selector member 6, to which a given setpoint value corresponds, said setpoint value itself being optimized for a given type of food. Thus, the time elapsing between the first and the second signals 8, 9 may be set as a function of the nature of the food to be cooked, which nature the management device 7 knows indirectly by means of the position of the pressure selector 6, which position corresponds to a setpoint value itself optimized for the given food. However, it is quite possible for the cooking management device 7 to take account of other parameters for setting the predetermined time that elapses between the first and the second signals 8, 9. For example, the cooking management device 7 may take account of the time that elapses between emission of the fourth signal and emission of the first signal 8, i.e. of the length of time of the first pressure-cooking stage. The weight of the food to be cooked, to which the management device 7 could have access via a suitable sensor, could also be taken into account for automatically setting the time elapsing between the first signal 8 and the second signal 9.

Conversely, it is quite possible, without going beyond the ambit of the invention, for the cooking management device 7 to be designed so that the time that elapses between the first and the second signals 8, 9 is a fixed predetermined length of time that does not depend on any parameter.

Thus, the invention makes it possible to implement a regulated-pressure first cooking stage for a precise predetermined time that corresponds to the time elapsing between the fourth signal and the first signal 8, said regulated-pressure first cooking stage being followed by a gentle second cooking stage, with the heat source off and preferably with the decompression member activated, the gentle second cooking stage also being implemented for a predetermined length of time that is preferably a function of the nature of the food to be cooked and/or of the setpoint value selected by the user by means of the pressure selector member 6 for the first cooking stage. This second cooking stage that starts from emission of the first signal 8 takes place in controlled manner, for a time that is fully controlled by means of the timing performed by the management device 7.

The invention also relates per se to such a food-cooking system comprising firstly a cooking utensil 1 as described above, and secondly a recipe booklet indicating a cooking time for at least one food, said cooking time indicated in the recipe booklet in question corresponding to the time elapsing between the fourth signal and the first signal 8. In other words, the recipe booklet indicates, for a given food (optionally as a function of the weight to be cooked), a cooking time that is to be entered by the user via the setting means 13, this cooking time corresponding to the time elapsing between emission of the fourth signal and emission of the first signal 8. The use of a booklet as a physical information medium is particularly advantageous in view of its simplicity and of its low cost.

Naturally, the cooking time indicated in the booklet takes account of the fact that, at the end of the pressure-cooking stage, a “pressure-less” cooking stage takes place. Therefore, the cooking time indicated in the booklet is shorter than the cooking time indicated in prior art recipe booklets, which booklets make provision for only one pressure-cooking operation, without any consecutive gentle cooking operation for a predetermined time.

Operation of the cooking utensil 1 shown in the figures is described below.

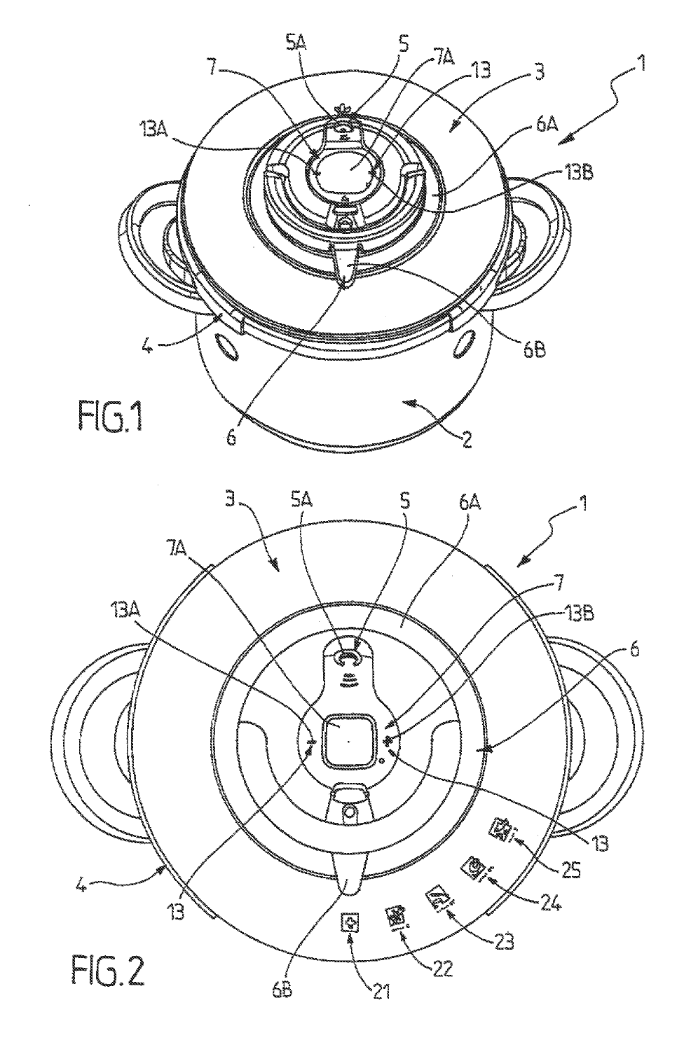

Firstly, the user puts the food to be cooked into the vessel 2, the food being constituted, for example, by a piece of fish. The user then puts the lid 3 onto the vessel 2 and locks said lid 3 on the vessel 2, so as to form a substantially sealed cooking enclosure capable of being brought up to pressure. At this instant, the pressure selector 6 is in the open position, as shown in FIG. 2, i.e. the decompression member is activated, the cooking enclosure thus being in communication with the outside and therefore not being able to be brought up to pressure. The cooking management device 7 is inactivated, its screen 7A therefore being blank. The user then programs the cooking time, i.e. sets the pressure-cooking time and launches said pressure-cooking stage.

To achieve this, the user may proceed in two manners.

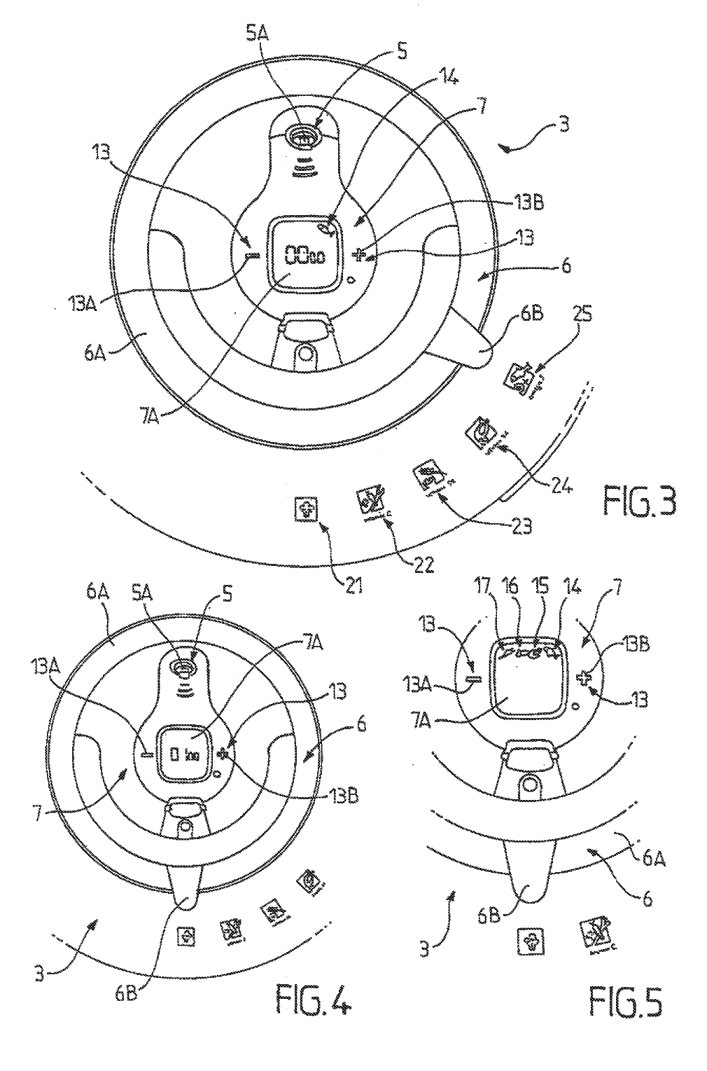

In a first manner, shown in FIG. 3, the user moves the pressure selector member 6 to select a cooking position corresponding to the food that is to be cooked, which food is constituted by a piece of fish in this example.

The finger 6B is thus turned manually by the user so as to be positioned facing the icon 25 showing a fish symbol drawn on the lid 3 and corresponding to a fourth cooking position, i.e. to a fourth predetermined setpoint value. The pressure selector member 6 being moved from its open (decompression) position to one of its cooking positions, and, in this example, to its fourth cooking position, sends an activation signal for activating the cooking management device 7 that causes the screen 7A to be switched on, which screen then displays firstly an image 14 symbolizing the cooking position selected by the user (in this example, the image 14 shows a fish), and secondly displays four zeros, preferably in flashing manner, so as to urge the user to program a cooking time by means of the buttons 13A, 13B.

In an alternative manner of use, as shown in FIG. 4, the user can leave the pressure selector member 6 in the open position, and can press directly on the buttons 13A, 13B, thereby causing the screen 7A to be activated and enabling the user to enter the cooking time. In this alternative manner of cooking, the user must naturally remember then to select a cooking position. If, after a predetermined time, the user has entered a cooking time by using the buttons 13A, 13B but has not moved the finger 6B to a cooking position, then an error message is displayed, as shown in FIG. 5, so as to remind the user to select a cooking position. This error message may, for example, consist in emission of a warning sound coupled with simultaneous display, preferably in flashing manner, of four symbols 14, 15, 16, 17 corresponding to respective ones of the four cooking positions that can be selected (in this example, the symbol 14 represents a fish, the symbol 15 a chicken, the symbol 16 potatoes, and the symbol 17 a carrot).

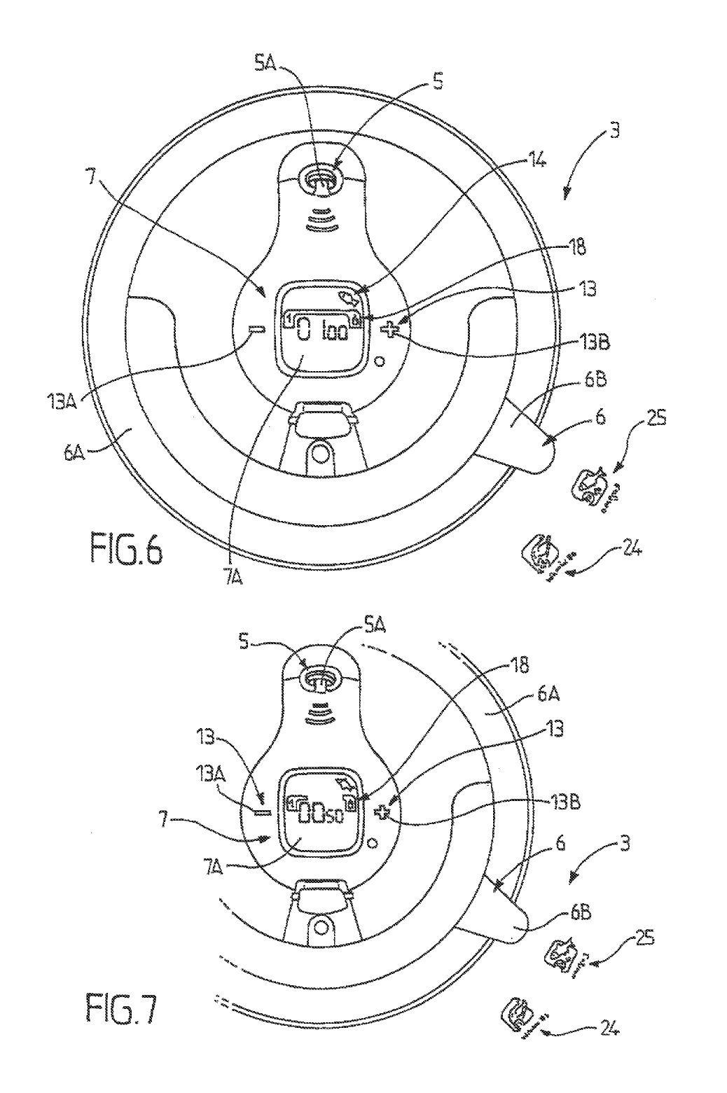

Once a cooking position has been selected, and once a cooking time has been programmed by the user, the screen 7A displays, as shown in FIG. 6:

the cooking time programmed by the user;

an image 14 reminding the user of the selected cooking position;

the numeral “1” indicating that the programmed cooking time corresponds to the length of time of a pressure-cooking first stage; and

a symbol 18 reminding the user that, during this first cooking stage, the heat source should be on.

The cooking enclosure containing the food is then stood on a hob that is switched on and set to maximum power by the user.

As soon as the pressure prevailing in the cooking enclosure reaches the setpoint value, the management device 7 emits the fourth signal, e.g. in the form of a sound, so as to urge the user to reduce the power of the heat source, but without switching off said heat source (as the user is reminded by the image 18). Simultaneously, the cooking management device 7 triggers the count-down of the cooking time that has been programmed by the user. The cooking time programmed by the user was procured by said user from the recipe booklet.

Once the cooking time programmed by the user has been counted down in full, the screen 7A displays four zeros (for zero minutes and zero seconds) and simultaneously emits the first signal 8 and the third signal 10 urging the user respectively to switch off the heat source and to activate the decompression member. The first signal 8 is, for example, constituted by a crossed-out flame, while the third signal 10 represents a cloud of steam symbolizing decompression. These images, displayed on the screen 7A, are preferably accompanied by a sound attracting the attention of the user.

The user then brings the pressure selector member 6 back into the open position, thereby causing the cooking enclosure to be decompressed. Then a second cooking stage starts, the user being reminded that this stage is being implemented by the numeral “2” and a crossed-out flame being displayed on the screen 7A. The screen 7A also displays the count-down of a predetermined time that is the cooking time of the second cooking stage. An image 19 symbolizing a closed pressure cooker is also displayed on the screen 7A so as to remind the user that the lid 3 must not yet be opened. The time that is counted down by the management device 7, which count-down is displayed by the screen 7A, is determined automatically by the processor means of the management device 7 as a function of the position that the pressure selector member 6 occupied during the first cooking stage, as shown in FIGS. 7 and 8.

Once the time of the second cooking stage has been counted down to its end, the screen 7A displays four zeros to indicate that the count-down has finished, and emits the second signal 9 in the form, for example, of an image displayed on the screen 7A and symbolizing a pressure cooker with its lid open, so as to indicate to the user that the cooking is fully finished and that the user can access the food.

By means of this precisely controlled sequential cooking method, with two different cooking stages implemented for precise times, the food does not suffer from any phenomenon of overcooking and is particularly tender.

This sequential cooking principle also makes it possible to preserve the vitamins in the food optimally.

In addition, the decompression member is advantageously designed so that the decompression is as slow and therefore as gentle as possible, without however the full decompression time exceeding the time of the second cooking stage (time elapsing between emission of the first signal 8 and emission of the second signal 9). Thus, when the second signal 9 is emitted, the user can open the lid 3 directly, since the utensil has been brought back substantially to atmospheric pressure during the “pressure-less” second cooking stage.

The invention also relates per se to a method of cooking food by subjecting said food to a heat source, said method being suitable for being implemented by the utensil described above and comprising:

a first cooking stage during which the food is disposed in an enclosure subjected to a heat source and in which a pressure prevails that is maintained substantially constant at a predetermined value that is significantly greater than atmospheric pressure;

a second cooking stage during which the heat source is switched off and the pressure value prevailing in the enclosure is progressively reduced to substantially the value of atmospheric pressure; and

a determination step for determining the time of the second cooking stage so that the second cooking stage is implemented for a predetermined time.

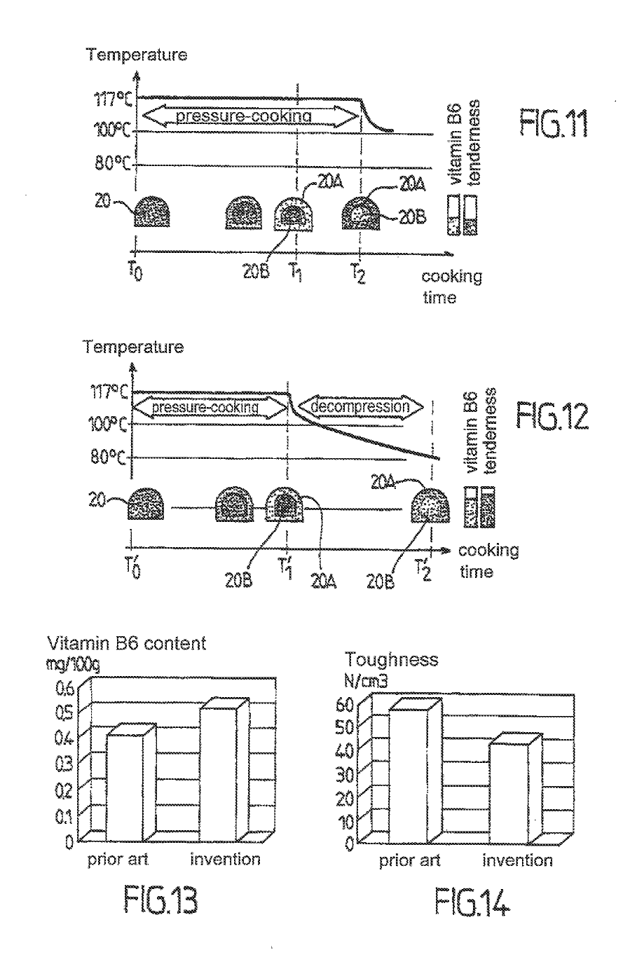

Advantageously, the time of the second cooking stage is determined, during said above-mentioned determination step, as a function of the nature of the food to be cooked. In which case, the method of the invention thus includes a determination step for determining the time of the second cooking stage as a function of the nature of the food to be cooked, so that the second cooking stage is implemented for a predetermined time calculated as a function of the nature of the food to be cooked. Advantageously, the time of the second cooking stage is determined by taking account of the position of the pressure selector member, which position corresponds to a predetermined setpoint value that indirectly indicates the nature of the food to be cooked. The second cooking stage thus takes place for a predetermined time, which is preferably sufficient for the pressure in the enclosure to have returned substantially to the same level as atmospheric pressure. The graphs in FIGS. 11 and 12 summarize the cooking principle of the invention (FIG. 12) in comparison with prior art cooking (FIG. 11). This principle is applied, in this example, to a slice of pork roast 20 of a weight of 130 grams (g) placed in a pressure cooker 1 for the purpose of being cooked therein. The slice of pork roast 20 is initially raw. In the prior art, as shown in FIG. 11, the slice of pork roast 20 is subjected to a pressure-cooking stage, e.g. at a pressure regulated at 85 kilopascals (kPa), between an instant T₀ marking the start of the pressure-cooking and an instant T₂ marking the end of the pressure-cooking. As shown in FIG. 11, the surface layers 20A of the slice of roast 20 are well cooked at an instant T₁ that is prior to the instant T₂.

However, at said instant T₁, the core 20B of the slice of pork roast 20 is not yet well cooked, since the temperature of said core 20B has not reached the threshold of 75° C. from which hemoglobin, and thus the pink color of the meat, disappears. The cooking is therefore continued until the final instant T₂ at which the core 20B is correctly cooked. However, the surface layers 20A have then suffered overcooking between the instants T₁ and T₂. As from the instant T₂, the cooking utensil is decompressed suddenly and in non-controlled manner by the user so as to gain access to the food as quickly as possible.

Conversely, in the cooking method of the invention shown in FIG. 12, the slice of pork roast 20 is subjected to a first pressure-cooking stage for a predetermined time between an initial instant T′₀ and an intermediate instant T′₁. At the intermediate instant T′₁, the surface layers 20A of the slice of roast 20 are well cooked, while the core 20B of the slice 20 is not yet sufficiently cooked. As from the instant T′₁, the second cooking stage starts, during which the heat source is switched off and the decompression member is activated, decompression taking place progressively throughout the time of this second cooking stage that extends to a final instant T′₂. By means of the gentle nature of this second cooking stage that is implemented between the instants T′₁ and T′₂, the core 20B of the slice of roast 20 is correctly cooked at the instant T′₂, as are the surface layers 20A of said slice 20 that have not suffered overcooking since the second cooking stage is a low-energy stage. As shown in FIG. 12, the decompression takes place progressively throughout all or some fraction of the second cooking stage, between the instants T′₁ and T′₂, so that, at the instant T′₂, the user can immediately access the slice of roast that is fully and uniformly cooked.

This manner of cooking thus makes it possible to improve the tenderness of the slice of roast 20 and to preserve its vitamin 36 content, as shown in FIGS. 13 and 14. Thus, the graph of FIG. 13 shows that the utensil 1 and the method of the invention make it possible to preserve up to 25% more vitamin 36 than with a conventional manner of cooking in a conventional pressure cooker. This vitamin 36 preservation is particularly important insofar as vitamin 36 is beneficial for amino acid metabolism, in antibody synthesis, and in general for the immune system.

FIG. 14 shows a reduction in the toughness of the meat, and thus an increase in the tenderness of the meat, which is an essential organoleptic criterion for meat cooking. The utensil 1 and the corresponding method of the invention thus make it possible to obtain a gain of about 25% in terms of tenderness, compared with conventional cooking in a conventional pressure cooker.

### SUSCEPTIBILITY OF INDUSTRIAL APPLICATION

The invention finds industrial application in the design, fabrication and use of cooking utensils, especially of utensils for cooking under pressure of the pressure cookers type.

1. A utensil (1) for cooking food by subjecting said food to a heat source, said utensil (1) being characterized in that it is provided with a cooking management device (7) that is designed to emit firstly a first signal (8) either for causing the heat source to be switched off or for urging the user to switch off the heat source, and secondly a second signal (9) subsequent to the first signal (8) and that indicates to the user that cooking is finished.

2. A utensil (1) according to claim 1, characterized in that it is designed to form a cooking enclosure making it possible to cook said food under pressure, and in that it is provided with a decompression member for said cooking enclosure, said cooking management device (7) being designed to emit a third signal (10) either for causing the decompression member to be activated or for urging the user to activate said decompression member.

3. A utensil (1) according to claim 2, characterized in that the decompression member is connected to the cooking management device (7) so that the cooking management device (7) emits a reminder signal if the decompression member has not been activated by the user in spite of the third signal (10) urging said user to do so.

4. A utensil (1) according to claim 2, characterized in that the cooking management device (7) is designed to emit said first and third signals (8, 10) substantially simultaneously.

5. A utensil (1) according to claim 2, characterized in that the cooking management device (7) is provided with detector means for detecting that a predetermined pressure value has been reached in the enclosure, said cooking management device (7) being designed so that, when said predetermined pressure value is detected, said cooking management device emits a fourth signal that is prior to the first signal (8) and that is designed either to cause the power of the heat source to be reduced, or to urge the user to reduce the power of the heat source.

6. A utensil (1) according to claim 5, characterized in that it is provided with setting means (13) enabling the user to set at least the time that elapses between the fourth signal and the first signal (8).

7. A utensil (1) according to claim 2, characterized in that it is provided with:
regulator means (5) for regulating the pressure value prevailing in the cooking enclosure so as to maintain said pressure at a setpoint pressure; and with
a pressure selector member (6) enabling the user to set said setpoint value;
said cooking management device (7) being provided with processor means connected to the pressure selector member (6) so as automatically to set the time elapsing between the first and the second signals (8, 9) as a function of said setpoint value.

8. A utensil (1) according to claim 1, characterized in that the signals (8, 9, 10) that said cooking management device (7) is designed to emit are of audible and/or visible nature.

9. A food-cooking system comprising firstly a cooking utensil (1) according to claim 6, and secondly a recipe booklet indicating a cooking time for at least one food, said cooking time indicated in the recipe booklet corresponding to the time elapsing between the fourth signal and the first signal (8).

10. A method of cooking food by subjecting said food to a heat source, said method comprising:
a first cooking stage during which the food is disposed in an enclosure subjected to a heat source and in which a pressure prevails that is maintained substantially constant at a predetermined value that is significantly greater than atmospheric pressure;
a second cooking stage during which the heat source is switched off and the pressure value prevailing in the enclosure is progressively reduced to substantially the value of atmospheric pressure; and
a determination step for determining the time of the second cooking stage so that the second cooking stage is implemented for a predetermined time.

11. A utensil (1) according to claim 3, characterized in that the cooking management device (7) is designed to emit said first and third signals (8, 10) substantially simultaneously.

12. A utensil (1) according to claim 3, characterized in that the cooking management device (7) is provided with detector means for detecting that a predetermined pressure value has been reached in the enclosure, said cooking management device (7) being designed so that, when said predetermined pressure value is detected, said cooking management device emits a fourth signal that is prior to the first signal (8) and that is designed either to cause the power of the heat source to be reduced, or to urge the user to reduce the power of the heat source.

13. A utensil (1) according to claim 4, characterized in that the cooking management device (7) is provided with detector means for detecting that a predetermined pressure value has been reached in the enclosure, said cooking management device (7) being designed so that, when said predetermined pressure value is detected, said cooking management device emits a fourth signal that is prior to the first signal (8) and that is designed either to cause the power of the heat source to be reduced, or to urge the user to reduce the power of the heat source.

14. A utensil (1) according to claim 3, characterized in that it is provided with:
regulator means (5) for regulating the pressure value prevailing in the cooking enclosure so as to maintain said pressure at a setpoint pressure; and with
a pressure selector member (6) enabling the user to set said setpoint value;
said cooking management device (7) being provided with processor means connected to the pressure selector member (6) so as automatically to set the time elapsing between the first and the second signals (8, 9) as a function of said setpoint value.

15. A utensil (1) according to claim 4, characterized in that it is provided with:
regulator means (5) for regulating the pressure value prevailing in the cooking enclosure so as to maintain said pressure at a setpoint pressure; and with
a pressure selector member (6) enabling the user to set said setpoint value;
said cooking management device (7) being provided with processor means connected to the pressure selector member (6) so as automatically to set the time elapsing between the first and the second signals (8, 9) as a function of said setpoint value.

16. A utensil (1) according to claim 5, characterized in that it is provided with:
regulator means (5) for regulating the pressure value prevailing in the cooking enclosure so as to maintain said pressure at a setpoint pressure; and with
a pressure selector member (6) enabling the user to set said setpoint value;
said cooking management device (7) being provided with processor means connected to the pressure selector member (6) so as automatically to set the time elapsing between the first and the second signals (8, 9) as a function of said setpoint value.

17. A utensil (1) according to claim 6, characterized in that it is provided with:
regulator means (5) for regulating the pressure value prevailing in the cooking enclosure so as to maintain said pressure at a setpoint pressure; and with
a pressure selector member (6) enabling the user to set said setpoint value;
said cooking management device (7) being provided with processor means connected to the pressure selector member (6) so as automatically to set the time elapsing between the first and the second signals (8, 9) as a function of said setpoint value.

18. A utensil (1) according to claim 2, characterized in that the signals (8, 9, 10) that said cooking management device (7) is designed to emit are of audible and/or visible nature.

19. A utensil (1) according to claim 6, characterized in that the signals (8, 9, 10) that said cooking management device (7) is designed to emit are of audible and/or visible nature.

20. A utensil (1) according to claim 7, characterized in that the signals (8, 9, 10) that said cooking management device (7) is designed to emit are of audible and/or visible nature.
